(19) United States
(12) Patent Application Publication
(10) Pub. No.: US 2012/0006078 A1
(43) Pub. Date: Jan. 12, 2012

(54) System And Method To Secure A Device

(76) Inventors: Peter M. On, Houston, TX (US); Dustin L. Hoffman, Cypress, TX (US); William Adam Gralewski, Houston, TX (US); Eric Chen, Houston, TX (US)

(21) Appl. No.: 13/255,928

(22) PCT Filed: Mar. 13, 2009
(86) PCT No.: PCT/US2009/037117

§ 371 Date: Sep. 12, 2011

(51) Int. Cl. E05B 73/00; E05B 67/00

(52) U.S. Cl. 70/22; 70/20; 29/525.01

(57) ABSTRACT

An exemplary embodiment of the present invention provides a system for securing a device. The system comprises a securing mechanism with a first end and a second end, wherein the first end is configured to be inserted through an opening in a device and the second end is configured to be trapped by the opening. The system also comprises a locking mechanism configured to lock to the first end of the securing mechanism.

### BACKGROUND

Portable electronic devices, such as lap top and palm top computers, cell phones, and the like, are useful for working in locations that are remote from an office. However, the portability of these devices makes them targets for theft, which may have consequences for the user and owner of the device as well as numerous others. For example, theft of an unsecured laptop may lead to loss of information that may result in identity theft, industrial espionage, and the like.

Locking devices for securing portable electronic devices are available, but are often permanently mounted in or on the portable device. If a locking device is mounted on the portable electronic device, it may provide an inconvenient protrusion to the shape of the device. If built into a portable electronic device, the locking devices may control the thickness of the portable electronic device, interfering with efforts to design smaller devices.

### BRIEF DESCRIPTION OF THE DRAWINGS

Certain exemplary embodiments are described in the following detailed description and in reference to the drawings, in which:

FIG. 1 is an illustration of a device secured to a structure by a cable, in accordance with an exemplary embodiment of the present invention;

FIG. 2 is a close-up view of a securing location on a device, in accordance with an exemplary embodiment of the present invention;

FIG. 3 is an illustration of a device that shows a tapered opening to allow the insertion of a securing mechanism, in accordance with an exemplary embodiment of the present invention;

FIG. 4 is a front view of a device that shows another view of the tapered opening of FIG. 3, in accordance with an exemplary embodiment of the present invention;

FIG. 5 is an illustration of a securing mechanism, in accordance with an exemplary embodiment of the present invention;

FIG. 6 is a front view of the securing mechanism of FIG. 5 being inserted through the tapered opening of the device of FIG. 4, in accordance with an exemplary embodiment of the present invention;

FIG. 7 is a front view of the device after insertion of the securing mechanism through the tapered opening, in accordance with an exemplary embodiment of the present invention;

FIG. 8 is an illustration of a locking mechanism being slid over the first end of the securing mechanism, in accordance with an exemplary embodiment of the present invention;

FIG. 9 is a cut-away view of a locking mechanism engaged with the first end of the securing mechanism, in accordance with an exemplary embodiment of the present invention;

FIG. 10 is an illustration of a locking cable that has a locking mechanism designed to engage a securing mechanism, in accordance with an exemplary embodiment of the present invention;

FIG. 11 is an illustration of a locking mechanism configured to engage both a securing mechanism and a locking head on a locking cable, in accordance with an exemplary embodiment of the present invention; and

FIG. 12 is an illustration showing a locking cable being secured to a structure prior to engaging the locking mechanism with a securing mechanism, in accordance with an exemplary embodiment of the present invention.

### DETAILED DESCRIPTION OF SPECIFIC EMBODIMENTS

As discussed herein, electronic devices (for example printers, computers, servers, copiers, and the like) are vulnerable to theft, at least in part because they have a relatively high value with respect to their weight. Portable electronic devices (for example, lap-top computers, net-book computers, palm-top computers, cell phones, and personal digital assistants, among others) are especially vulnerable due to their use in public places while traveling. Exemplary embodiments of the present invention provide systems and methods for securing electronic devices without the use of fixed attachments, protrusions, or built in devices. Further, exemplary embodiments of the present invention may be used to secure other items, for example, letter boxes, cash boxes, donation boxes, briefcase, or file boxes, among others.

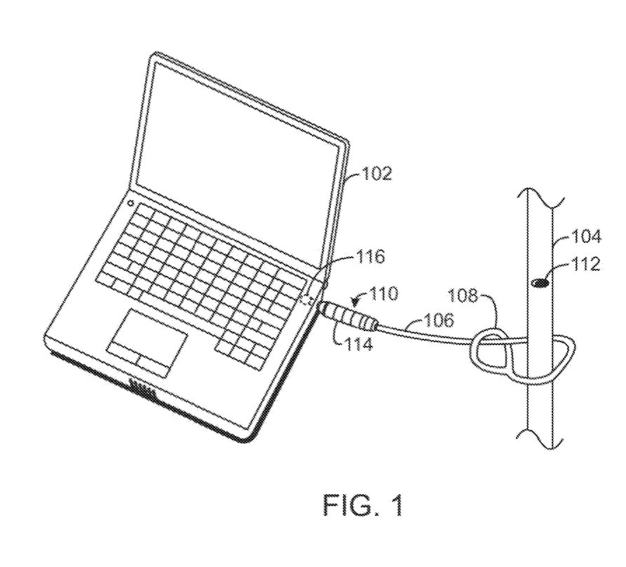

FIG. 1 is an illustration of a device 102 secured to a structure 104 by a cable 106, in accordance with an exemplary embodiment of the present invention. As shown in this exemplary embodiment, the cable 106 may have a loop 108 located at one end. Accordingly, the cable 106 may be secured to the structure 104 by looping the cable 106 around the structure 104, and then inserting an opposite end 110 of the cable 106 through the loop 108. In other exemplary embodiments, the loop 108 may be replaced with a fixed element, for example, a hook or a metal bar (not shown), designed to prevent the cable 106 from being pulled through an opening in the structure 104. In this embodiment, the cable 106 may be secured to the structure 104 by inserting the opposite end 110 through a feature on the structure 104, for example, through a hole 112 in the structure 104. The structure 104 may include any suitable structure that can be used to secure the device 102, for example, a car bumper, a pipe, a chair, a conduit, a table, an airport seat, and the like.

The opposite end 110 of the cable 106 from the loop 108 may include a locking mechanism 114 configured to lock the cable 106 to the device 102. In an exemplary embodiment of the present invention, the locking mechanism 114 may lock to the device 102 by attaching to a securing mechanism (as discussed below) that is inserted through an opening 116 constructed into the device 102. One of ordinary skill in the art will appreciate that the device 102 may include a lap-top computer, a net-book computer, a palm-top computer, a cell phone, a personal digital assistant, a printer, a server, a copying machine, a fax machine, a monitor, audio equipment, video equipment, a television, a projector, a cash register, and many other types of electronic devices. Further, exemplary embodiments of the present invention may be used to secure other items, for example, a briefcase, a computer case, a cash box, a letter box, a donation box, and the like. Accordingly, one of ordinary skill in the art would consider these items to be within the scope of the present claims.

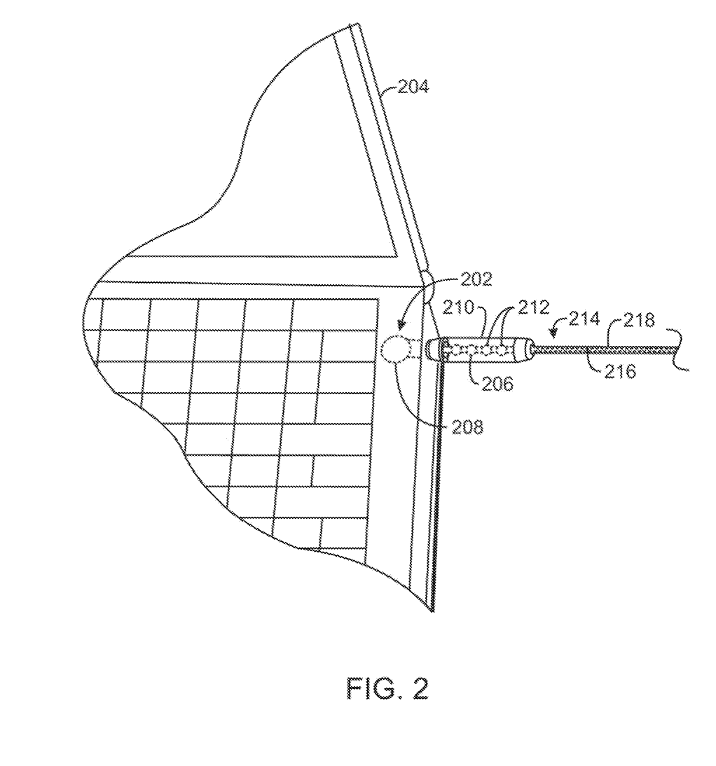

FIG. 2 is a close up view of a securing location 202 on a device 204, in accordance with an exemplary embodiment of the present invention. As discussed in further detail below, a securing mechanism 206 is inserted through an opening 208 in the device 204. The securing mechanism 206 may be inserted into a locking mechanism 210, which locks to structural features 212 on the securing mechanism 206. In this exemplary embodiment of the present invention, the locking mechanism 210 is built into the end of a cable 214. The cable 214 may have an inner core 216 formed from a flexible cable (for example, a braided steel cable) and an outer layer 218 of a protective material (for example, polyvinyl chloride or PVC). In another exemplary embodiment, a locking mechanism may be attached between a cable and a device, as discussed with respect to FIG. 11.

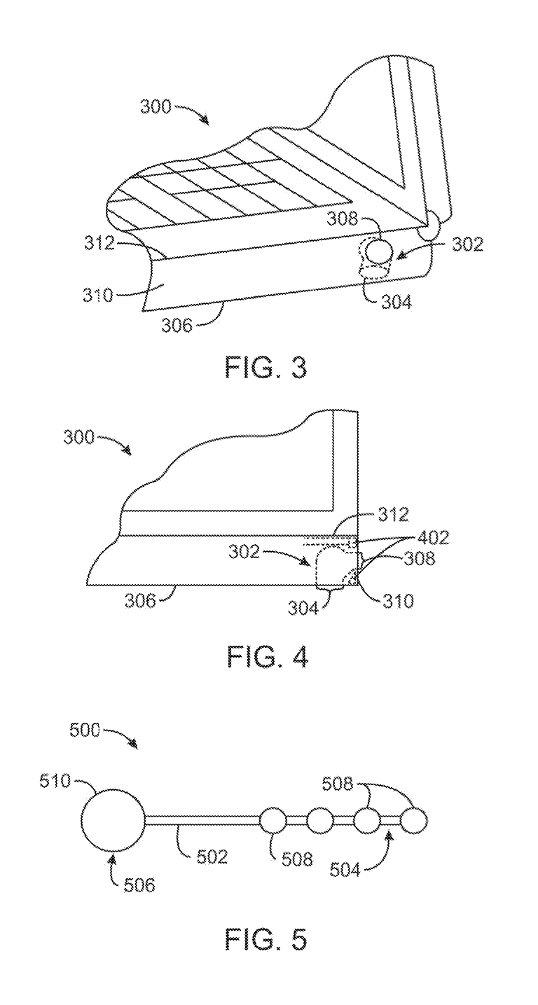

FIG. 3 is an illustration of a device 300 that shows a tapered opening 302 to allow the insertion of a securing mechanism, in accordance with an exemplary embodiment of the present invention. As shown, the tapered opening 302 connects a first hole 304 (for example, located in the bottom 306 of the device 300), to a smaller hole 308 (for example, located in a side 310 of the device 300). A securing mechanism may be inserted through the first hole 304 of the tapered opening 302, with a structure on the securing mechanism trapped in the device 300 by the smaller hole 308.

FIG. 4 is a front view of the device 300 that shows the tapered opening 302, in accordance with an exemplary embodiment of the present invention. As shown in FIG. 4, the tapered opening 302 may generally be formed in the frame 402 of the device 306, thus improving the security of the locking. However, if the device has no frame (for example, a laptop with a titanium case) the tapered opening 302 may be formed directly into the case itself.

As would be clear to one of ordinary skill in the art, the tapered opening is not limited to the configuration shown in FIGS. 3 and 4. For example, in another exemplary embodiment of the present invention, the tapered opening could connect a first hole on the top of the device to a smaller hole located on a side of the device. Further, other types of devices may use any number of other configurations. For example, if the device is a box (e.g., for donations or letters) or a briefcase, a single hole could be formed through the device, from the inner surface to the outer surface.

FIG. 5 is an illustration of a securing mechanism 500, in accordance with an exemplary embodiment of the present invention. In exemplary embodiments of the present invention, the securing mechanism 500 includes a center body 502, which has a first end 504 and a second end 506. The first end 504 of the securing mechanism 500 may be inserted through an opening, such as the tapered opening 302 discussed with respect to FIGS. 3 and 4. The second end 506 of the securing mechanism 500 may then be trapped by the opening.

In the exemplary embodiment illustrated in FIG. 5, the first end 504 of the securing mechanism 500 may include one or more spheres 508 that may be trapped in a locking mechanism. The second end 506 may have a single, larger sphere 510, configured to be trapped by an opening having a diameter that is smaller than the larger sphere 510, such as the smaller hole 308 of the tapered opening 302, discussed with respect to FIGS. 3 and 4.

The securing mechanism 500 is not limited to the configuration shown in FIG. 5. Indeed, one of ordinary skill in the art will recognize that any number of other geometric configurations may be used for the ends 504 and 506 of the securing mechanism. For example, in another exemplary embodiment of the present invention, the first end 504 may include a bar that is perpendicular to the center body 502 and is configured to be locked into a locking mechanism. The second end 506 could then be the larger sphere 510 shown or could be a second bar configured to be trapped in a slot on the device. Further, in other exemplary embodiments of the present invention, the spheres 508 and 510 could be replaced with cubes, perpendicular bars, or any other geometric configurations that are suitable for securing a device to a locking mechanism.

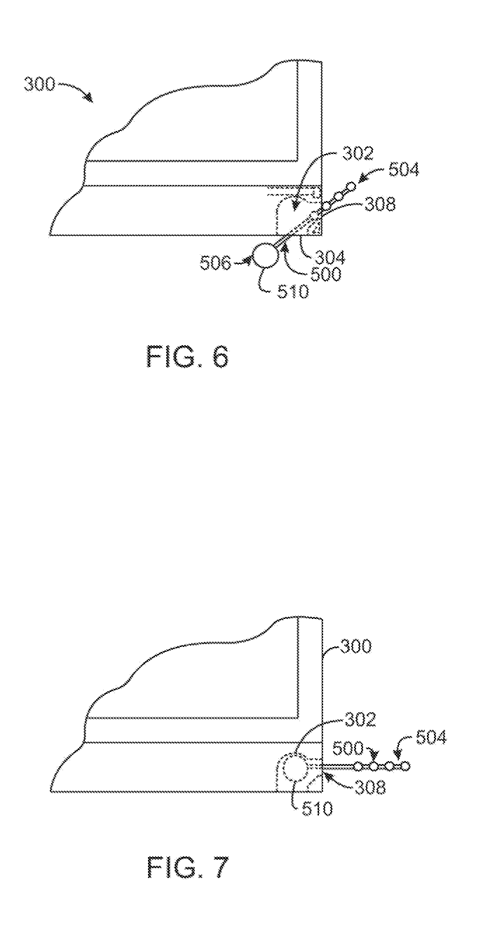

In exemplary embodiments, all or part of the central body 502 of the securing mechanism 500 may be flexible to allow for easier insertion into a securing location, as discussed with respect to FIG. 6. For example, the portion of the central body 502 having the attached spheres 508 may be rigid (for example, formed from a single steel wire) to assist in insertion into a locking mechanism, while the portion of the central body 502 attaching the spheres 508 to the larger sphere 510 may be flexible (for example, formed from a steel cable).

FIG. 6 is a front view of the securing mechanism 500 of FIG. 5 being inserted through the tapered opening 302 of the device 300 of FIG. 4, in accordance with an exemplary embodiment of the present invention. Generally, the first end 504 of the securing mechanism 500 is inserted through the first hole 304 and out the smaller hole 308. The larger sphere 510 located at the second end 506 of the securing mechanism 500 may then be trapped in the tapered opening 302 as the diameter of the larger sphere 510 may generally be greater than the diameter of the smaller hole 308.

FIG. 7 is a front view of the device 300 after insertion of the securing mechanism 500 into the tapered opening 302, in accordance with an exemplary embodiment of the present invention. As can be seen in FIG. 7, the larger sphere 510 of the securing mechanism 500 is trapped in the tapered opening 302 by the smaller diameter of the smaller home 308. Accordingly, the second end 504 of the securing mechanism 500 is left open for attachment to a locking mechanism.

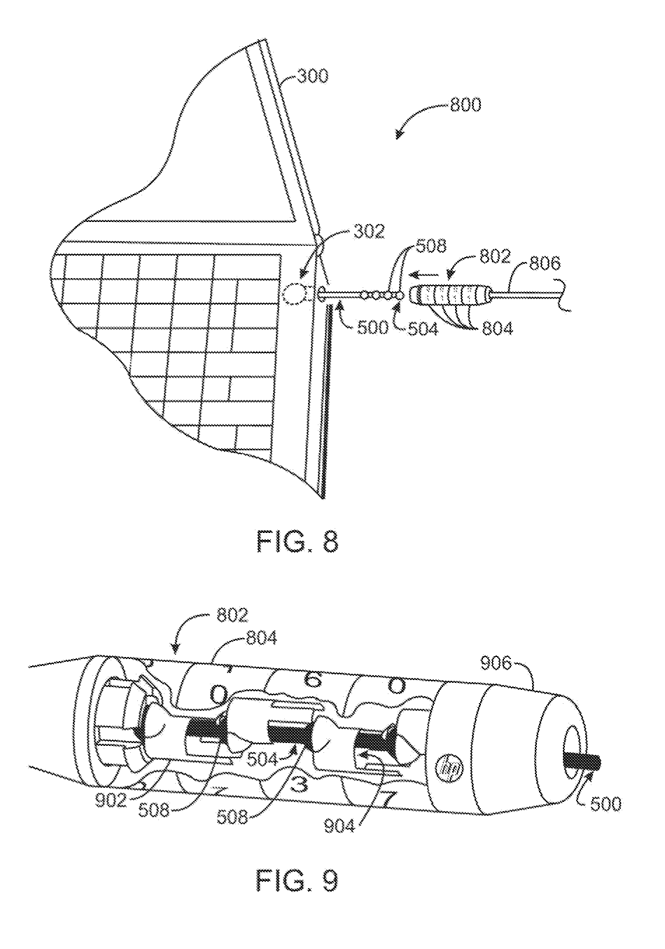

FIG. 8 is an illustration of a locking mechanism 802 being slid over the first end 504 of a securing mechanism 500 that is trapped in a tapered opening 302 in a device 300, in accordance with an exemplary embodiment of the present invention. The smaller spheres 508 of the securing mechanism 500 may then be trapped by the locking mechanism 802, for example, by spinning numerical dials 804 on a combination lock. Once the first end 504 of the securing mechanism 500 is trapped in the locking mechanism 802, the securing mechanism 500 cannot be removed from the device 300. Accordingly, the locking mechanism 802 is then secured to the device 300 until the correct combination is entered on the dials 804 to free the first end 504 of the securing mechanism 500. A cable 806 that is joined to the locking mechanism 802 and secured to a structure may then prevent removal of the device 300 from the proximity of a structure.

FIG. 9 is a cut-away view of a locking mechanism 802 engaged with the first end 504 of the securing mechanism 500, in accordance with an exemplary embodiment of the present invention. As shown in this view, each smaller sphere 508 on the first end 504 of the securing mechanism 500 is engaged with an offset locking cam 902, which may prevent removal of the smaller sphere 508 from the locking mechanism 802. Each offset locking cam 902 is coupled to a numerical dial 804, which rotates the locking cam 902. At the preset number on the numerical dial 804, an opening 904 in the locking cam 902 is aligned with the smaller sphere 508 allowing it to be removed from locking mechanism 802. However, unless all of the smaller spheres 508 are aligned with their respective locking cams 902, the first end 504 of the securing mechanism 500 will remain locked in the locking mechanism 802.

The locking mechanism 802 may have a shroud 906 configured to prevent access to the securing mechanism 500. For example, the shroud 906 may prevent the securing mechanism 500 from being cut by a person intending to steal the device. The shroud 906 may be made of an elastic material, for example, rubber, PVC, or the like, to allow the shroud 906 to make direct contact with the device without damaging the device. Alternatively, the shroud 906 may be made from a steel sheath coated with an elastic material. The coated steel sheath may allow the shroud to contact the device without damage to the device, while providing enhanced resistance to cutting.

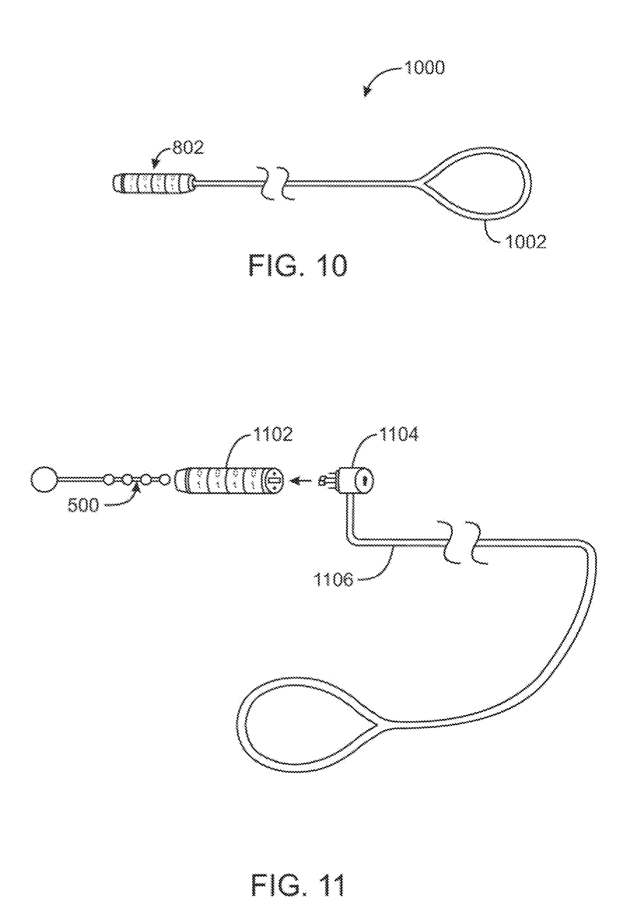

One of ordinary skill in the art will recognize that the locking mechanism 802 is not limited to the system illustrated in FIG. 9. For example, the first end 504 of the securing mechanism 500 may include a metal bar with slots that are designed to engage offset protrusions in the locking mechanism 802. Further, the locking mechanism 802 may be permanently joined to a cable, as shown in FIG. 10, or may be incorporated into an adapter to allow a previous cable to be used, as shown in FIG. 11.

FIG. 10 is an illustration of a locking cable 1000 that has a locking mechanism 802 designed to engage a securing mechanism, in accordance with an exemplary embodiment of the present invention. The cable 1000 may be made from a coated flexible steel cable and have a loop 1002 to facilitate securing the cable 1000 to a structure.

The cable 1000 does not have to be permanently joined to the locking mechanism 802. In exemplary embodiments of the present invention, the locking mechanism 802 may be incorporated into an adapter to allow the use of previously cables with the locking system described herein.

FIG. 11 is an illustration of an adapter 1102 configured to engage a securing mechanism 500 and a locking head 1104 on a locking cable 1106, in accordance with an exemplary embodiment of the present invention. Allowing for the use of a current cable 1106 may protect the investment that a user made in earlier technology.

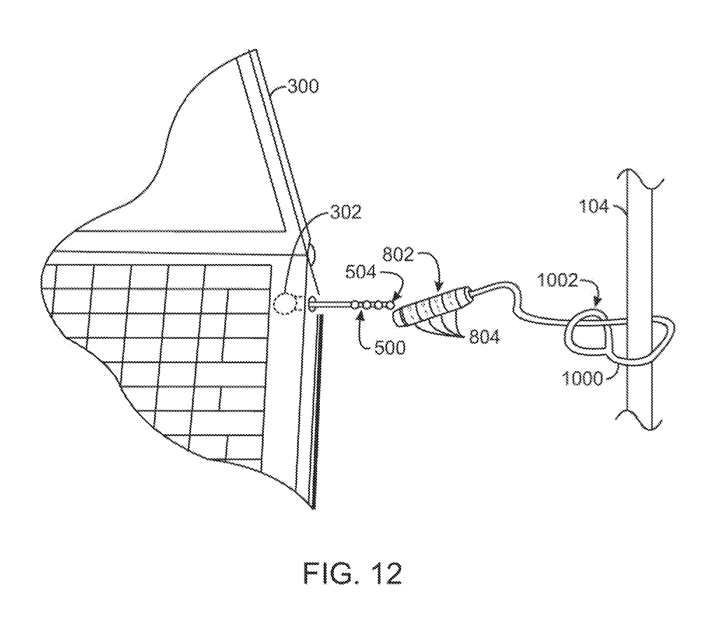

FIG. 12 is an illustration showing a cable 1000 being secured to a structure 104 prior to engaging a locking mechanism 802 on the cable 1000 with a securing mechanism 500, in accordance with an exemplary embodiment of the present invention. As shown in this illustration, the cable 1000 may be wrapped around the structure 104 and then the locking mechanism 802 inserted through a loop 1002 on the cable 1000. The securing mechanism 500 may then be inserted through the tapered opening 302 in the device 300. The first end 504 of the securing mechanism 500 may then be inserted into the locking mechanism 802 at the end of the cable 802. The numerical dials 804 may then be rotated to lock the securing mechanism 500 into the locking mechanism 802.

What is claimed is:

1. A system for securing a device, comprising:
a securing mechanism with a first end and a second end, wherein the first end is configured to be inserted through an opening in a device and the second end is configured to be trapped by the opening; and
a locking mechanism configured to lock to the first end of the securing mechanism.

2. The system of claim 1, wherein the device comprises a computer, a phone, a printer, a copier, a lap top computer, a personal digital assistant (PDA), a palmtop computer, or a netbook computer.

3. The system of claim 1, where the locking mechanism is configured to slide over the first end of the securing mechanism and lock the first end of the securing mechanism inside the locking mechanism.

4. The system of claim 1, wherein the locking mechanism comprises a combination lock cylinder configured to trap structures located on the first end of the securing mechanism.

5. The system of claim 1, wherein the securing mechanism comprises a metal cylinder with two or more spheres located in proximity to the first end of the metal cylinder and a single sphere located at the second end of the metal cylinder, wherein the single sphere has a larger diameter than the spheres located at the first end of the metal cylinder.

6. The system of claim 5, wherein the locking mechanism comprises a plurality of locking cams, wherein each locking cam is configured to trap one of the spheres located in proximity to the first end of the securing mechanism.

7. The system of claim 1, comprising a cable with a first end and a second end, wherein the first end of the cable is configured to be secured to a structure and the second end of the cable is joined to the locking mechanism.

8. The system of claim 7, wherein the cable is permanently mounted to the locking mechanism.

9. The system of claim 1, wherein the opening in the device comprises a tapered opening through the device.

10. A method for securing a device, comprising:
securing a first end of a cable to a structure, wherein a second end of the cable is joined to a locking mechanism;
inserting a first end of a securing mechanism through an opening in a portable device, wherein a second end of the securing mechanism is trapped in the opening; and
inserting the first end of the securing mechanism into the locking mechanism at the second end of the cable.

11. The method of claim 10, wherein securing the first end of the cable to the structure comprises:
wrapping the cable around the structure; and
inserting the second end of the cable through a loop formed in the first end of the cable.

12. The method of claim 10, wherein securing the first end of the cable to the structure comprises:
inserting the second end of the cable through an opening in the structure, wherein the first end of the cable is configured to be trapped by the opening in the structure.

13. A device, comprising:
an opening through the device, wherein the opening is configured to allow a first end of a securing mechanism to be inserted through the opening, and wherein the opening is configured to trap a second end of the securing mechanism in the opening.

14. The device of claim 13, comprising a computer, a phone, a printer, a copier, a lap top computer, a personal digital assistant (PDA), a palmtop computer, a netbook computer, a briefcase, a metal box, a mail box, a donation box, or a cash box.

15. The device of claim 13, wherein the opening comprises a first hole in one surface of a device joined to a second hole in another surface of the device, wherein the second hole is smaller than the first hole.
